(19) United States
(12) Patent Application Publication
(10) Pub. No.: US 2002/0004112 A1
(43) Pub. Date: Jan. 10, 2002

(54) Composite films having biaxially oriented polyethylene sealing layers

(76) Inventors: Harry Muller, Soltau (DE); Heiko Tamke, Bomlitz (DE)

Correspondence Address: William C. Gerstenzang, Norris McLaughlin & Marcus, P.A., 30th Floor, 220 East 42nd Street, New York, NY, 10017, US

(21) Appl. No.: 09/905,093

(22) Filed: Jul. 13, 2001

Related U.S. Application Data
(63) Continuation of application No. 09/648,085, filed on Aug. 25, 2000.

(30) Foreign Application Priority Data
Jul. 24, 1995 (DE) 195 26 922.5
Mar. 15, 1996 (DE) 196 10 263.4
Mar. 15, 1996 (DE) 196 10-264.2

(51) Int. Cl. B32B 1/00; B32B 27/40; B32B 15/08

(52) U.S. Cl. 428/35.3; 428/336; 428/335; 428/35.8; 428/35.9; 428/35.4; 428/36.7; 428/423.5; 428/423.7; 428/424.8; 428/425.8

(57) ABSTRACT

The present invention relates to multilayered composite films comprising a film or film combination A of plastics layers or metal layers in any arrangement, having an at least 10 μm thick, biaxially oriented heat-sealable layer C predominantly comprising polyethylene homopolymers or polyethylene copolymers, which is bonded by means of an adhesive layer or connecting layer B to the film or film combination A.

The present invention relates to multilayered composite films comprising a film or film combination A of plastics layers or metal layers in any arrangement, which are distinguished by possessing as an outer layer a biaxially oriented sealing layer C comprising a polyethylene homopolymer or a polyethylene copol ymer or mixtures or coextrusions of these materials in a thickness of from 10 to 50 μm, preferably from 15 to 30 μm, which is bonded by means of an adhesive layer or connecting layer B to the film or film combination A.

The use of multilayered composite films for packaging many different types of packaged goods is prior art. Through the layered combination of films having different properties, composite films having a set of properties which is far superior to that of single films are obtained. Composite films generally comprise at least one “support film”, which may optionally be printed, and a heat-sealable layer. Examples of typical support films are biaxially oriented films made of polypropylene, polyester or polyamide. Combinations of support films are also known, such as polyester/aluminium or polyester/metallised polyester, for example. The heat-sealable layers generally consist of a polyolefin. These composite films are processed, for example, in packaging machines, in which the films are shaped into the form of a container which is filled and then sealed (“form-fill-seal”). As a rule, high sealed seam strengths are required in order to prevent opening of the seam on exposure to mechanical stress.

It is prior art to use in such composite films non-oriented heat-sealable layers of polyethylene, polypropylene and/or copolymers thereof in thicknesses of from approximately 30 to 150 μm, which are mainly coated with adhesive.

Such composite films possess good sealing properties, but on being exposed to particular stresses they exhibit a number of disadvantages:

To achieve high sealed seam strengths it is necessary to use a large quantity of sealing layer material, which is inconsistent with the general demand for ever thinner and more efficient films.

Especially in the packaging of sharp-edged packaged goods such as, for example, breakfast cereals, an adequate resistance of the composite film to perforations is required. The resistance to perforation is generally achieved by using a composite film, and in particular a heat-sealable layer, which is of a minimum thickness.

Non-oriented heat-sealable layers make only a small contribution to the mechanical stability of the total composite. This is a disadvantage above all in composite films comprising non-oriented or monoaxially oriented support films and a non-oriented heat-sealable layer. Thus composites having longitudinally stretched support films possess an excellent mechanical stability in the lengthwise direction of the film, but a distinct mechanical weakness in the direction at right angles to the direction of orientation. A higher stability in these composite films is required, for example, where they are used as covering films.

In certain applications, for example, for the production of tubular bags, the two external sides of the composite films are required to be sealable against one another so as to enable the production of packaging materials from sheets of film which are as narrow as possible, and with the lowest possible use of material (seam overlapping behind, so-called “lap-seal”). Films of co-extruded, biaxially oriented polypropylene are generally used for these applications. Since, for the majority of applications, these films are printed or metallised, or additional plastics layers or metal layers are applied, a second outer layer is provided in the form of a heat-sealable layer which can be sealed against the first outer layer of coextruded, biaxially oriented polypropylene.

This heat-sealable layer consists either likewise of coextruded, biaxially oriented polypropylene or of non-oriented films made of polypropylene copolymers.

In the first case, owing to the extremely thin sealing layer (often <5 μm), the composite film provides only moderate sealed seam strengths. In the second case, occasioned by the production method and owing to the better workability, the sealing layers are mainly at least 30 μm thick.

A typical application for which thin, mechanically stable films are especially important is, for example, the production of balloons having sealed edges, of the type which are found at fairs. For this it is prior art to use thin, metallised and printed composite films having non-oriented polyethylene heat-sealable layers, which are welded at the edges and filled with helium gas. The total area weight of the composite films is limited by the requirement that such balloons be airworthy. Typical thicknesses of the non-oriented heat-sealable layers employed are in the range of 15 to 20 μm. They possess only a low mechanical strength and are very difficult to coat owing to their extensibility; during the production this results in low machine speeds or increased waste material.

In many cases, the inner film consisting of polyolefins undertakes not only the function of the heat-sealable layer, but in addition it fulfils the task of providing a barrier against water vapour. In such a case, the thickness of the film is determined by the level of the required barrier.

The object was accordingly to produce composite films having thin heat-sealable layers, which in the following respects are comparable with or superior to prior art:

quantity of material used

workability of the thin heat-sealable layers

mechanical strength of the total composite, in particular in non-oriented or monoaxially oriented support films or in combinations of such support films

resistance to perforation

sealed seam strengths where the heat-sealable layer is sealed against itself

sealed seam strengths where the heat-sealable layer is sealed against coextruded, biaxially oriented polypropylene (“lap-seal”)

barrier against water vapour

According to the invention this was achieved by the production of composite films which are characterised in that they possess a biaxially oriented heat-sealable layer C comprising polyethylene homopolymers or polyethylene copolymers or mixtures or coextrusions of these materials in thicknesses of from 10 to 50 μm, preferably from 10 to 30 μm, which is bonded by means of an adhesive layer or connecting layer B to the at least single-layered film or film combination A, referred to below as “support film”.

The support film A may consist of one or more individual layers, which may optionally be bonded to one another in any sequence by adhesive or adhesion-promoting intermediate layers.

Typical individual layers of the support film consist, for example of:

PA=polyamide

PP=polypropylene

EVOH=ethylene-vinyl alcohol copolymer

PVOH=polyvinyl alcohol

PET=polyethylene terephthalate

PEN=polyethylene naphthalate

PS=polystyrene

PMMA=poly(methyl methacrylate)

These individual layers may be contained in unstretched form or monoxially as well as in biaxially oriented form and, on their part, they may optionally be provided with functional layers such as, for example, sealable coatings or metallic or transparent inorganic or organic barrier layers. They may also contain layers made of metal, preferably aluminium.

In a preferred film structure, the support film A contains a coextruded, biaxially oriented polypropylene film as the outer layer.

In another preferred film structure, the support film A is a gas barrier film, consisting preferably of polyamide (PA), polyethylene (PE) or polypropylene (PP), and is monoaxially oriented in the machine direction. In a particularly preferred embodiment, this gas barrier film consists of PA or ethylene-vinyl alcohol copolymer (EVOH) or of the layered combination of PA and EVOH or of mixtures of PA and EVOH and is monoaxially oriented.

The heat-sealable layer C is a single-layered or multilayered, biaxially oriented film comprising a polyethylene homopolymer or a polyethylene copolymer such as, for example:

LLDPE=linear low density polyethylene

LDPE=low density polyethylene

HDPE=high density polyethylene

PB=polybutylene

EVA=ethylene-vinyl acetate

EBA=ethylene-butyl acrylate

EAA=ethylene-acrylic acid

EEA=ethylene-ethyl acrylate

EMAA=ethylene-methacrylic acid

I=ionomer or mixtures or coextrusions of these materials.

The materials preferably used for the at least single-layered heat-sealable layers C are mixtures containing at least 50% LLDPE with at most 50% polyethylene copolymers, particularly preferably LDPE, the density of the mixture being less than 0.94 g/cm³ and the MFI being less than 2 g/10 min.

The heat-sealable layer is made firmly-sealing or peelable from itself or from a second film.

The support film A and the heat-sealable layer C are bonded by means of an adhesive layer or connecting layer B. A reactive adhesive such as, for example, a one- or two-component polyurethane adhesive or an olefinic adhesion promoter such as, for example, an anhydride-modified ethylene-vinyl acetate is used for the adhesive layer.

Conventional additives and auxiliary substances such as, for example, lubricants. antiblocking agents, antistatic agents, TiO₂, CaCO₃ et cetera, may be added to the individual layers of the composite film.

Surprisingly, it has been found that during the sealing of the biaxially oriented heat-sealable layer against itself even very small sealing layer thicknesses lead to high sealed seam strengths. The sealed seam strengths achieved are in the range of those of conventional, non-oriented polyethylene heat-sealable layers of twice to three times the thickness, made of comparable material (Table 1). It has surprisingly been found, moreover, that the sealing of the biaxially oriented heat-sealable layer against coextruded, biaxially oriented polypropylene (BOPP) leads to higher sealed seam strengths (Table 2) than in the case of non-oriented, distinctly thicker heat-sealable layers made of polypropylene copolymers.

It is thereby possible to produce composite films for “lap-seal” applications which exhibit high seam strengths both on being sealed against themselves and on being sealed against coextruded, biaxially oriented polypropylene, with at the same time a significant saving of sealing-layer material.

It has also been found that thin, biaxially oriented heat-sealable layers can be processed very satisfactorily owing to their high mechanical strengths and do not give rise to the processing problems which are associated with non-oriented thin polyolefin films. The high mechanical strength of the heat-sealable layer definitely reinforces the mechanical strengths of the laminated films produced from them (Table 1), as well as the resistances of the latter to perforation. Above all in the case of monoaxially oriented support films there is a definite reinforcement of the strength at right angles to the lengthwise direction of the film.

Moreover, as a result of the biaxial orientation, the water-vapour permeability of a polyethylene film is influenced to such an extent that it corresponds to that of a non-oriented heat-sealable layer of twice to three times the thickness (Table 1).

Surprisingly, it has been found that the existing tendency to shrinkage of the biaxially oriented polyethylene heat-sealable layers used in the composite films according to the invention is almost completely suppressed when they are used in combination with the relatively non-shrinking support films selected. This is particularly surprising, since applications of such films as shrink films, both in the form of individual films and in laminates with shrinkable support films, are known (EP-A 214 314).

Methods of Measurement

The properties of the multilayered films according to the present invention are determined by the following methods.

The oxygen permeability of the films is determined in accordance with DIN 53 380, Part 3.

The water-vapour permeability of the films is determined in accordance with DIN 53 122.

The strength of the composite films is assessed by the tensile test on a tensile testing machine of the type Zwick 1445 (DIN 53 455).

The high-pressure strength of the seal is determined, in accordance with an internal test specification, by sealing the composite films using a laboratory sealing apparatus from the firm Brugger (conditions: sealing jaws smooth, heated on both sides, sealing area 20×60 mm², pressure 50 N/cm², time 0.5 s) and measuring the strength on a 15 mm wide strip on a tensile testing machine of the type Zwick 1445 (test speed: 100 mm/min).

The perforation force is determined, in accordance with an internal test specification, by means of an electronic tensile testing machine (test speed: 100 mm min) on a sample composite film stretched out in the form of a membrane (50 mm clamping diameter), using a test spike.

The MFI of the heat-sealable layers used was determined in accordance with DIN 53 735.

### EXAMPLE 1

| | |
|---|---|
| Layer A (support film): | gas barrier layer of coextrudate polyamide 6/ethylene- |
| | vinyl alcohol copolymer/polyamide 6, monoaxially |
| | oriented, 15 μm, type Walomid Combi XXL 15 |
| Layer B: | two-component polyurethane adhesive, 2 μm |
| Layer C (sealing layer): | sealing layer of LLDPE (linear low density |
| | polyethylene), biaxially oriented, |
| | MFI = 1.1 g/10 min, 15 μm |

### EXAMPLE 2

| | |
|---|---|
| Layer A (support film): | polyethylene terephthalate (PET), biaxially oriented, |
| | 12 μm, type Hostaphan RP 12 |
| Layer B: | two-component polyurethane adhesive, 2 μm |
| Layer C (sealing layer): | sealing layer of LLDPE (linear low density |
| | polyethylene), biaxially oriented, |
| | MFI = 1.1 g/10 min, 15 μm |

### EXAMPLE 3

| | |
|---|---|
| Layer A (support film): | coextruded polypropylene, biaxially oriented, 20 μm, |
| | type Walothen C20SE |
| Layer B: | two-component polyurethane adhesive, 2 μm |
| Layer C (sealing layer): | sealing layer of LLDPE (linear low density |
| | polyethylene), biaxially oriented, |
| | MFI = 1.1 g/10 min, 15 μm |

### EXAMPLE 4

| | |
|---|---|
| Layer A (support film): | coextruded polypropylene, biaxially oriented, 20 μm, |
| | type Walothen C20SE/two-component polyurethane |
| | adhesive 2 μm/aluminium foil 9 μm |
| Layer B: | two-component polyurethane adhesive, 2 μm |
| Layer C (sealing layer): | sealing layer of LLDPE (linear low density |
| | polyethylene), biaxially oriented, |
| | MFI = 1.1 g/10 min,15 μm |

### COMPARISON EXAMPLE 1

| | |
|---|---|
| Layer A (support film): | gas barrier layer of coextrudate polyamide 6/ethylene- |
| | vinyl alcohol copolymer/polyamide 6, monoaxially |
| | oriented, 15 μm, type Walomid Combi XXL 15 |
| Layer B: | two-component polyurethane adhesive, 2 μm |
| Layer C (sealing layer): | sealing layer of LLDPE (linear low density |
| | polyethylene), MFI = 1.4 g/10 min, 40 μm |

### COMPARISON EXAMPLE 2

| | |
|---|---|
| Layer A (support film): | polyethylene terephthalate (PET), biaxially oriented, |
| | 12 μm, type Hostaphan RP 12 |
| Layer B: | two-component polyurethane adhesive, 2 μm |
| Layer C (sealing layer): | sealing layer of LLDPE (linear low density |
| | polyethylene), MFI = 1.4 g/10 min, 40 μm |

### COMPARISON EXAMPLE 3

| | |
|---|---|
| Layer A (support film): | coextruded polypropylene, biaxially oriented, 20 μm, |
| | type Walothen C20SE |
| Layer B: | two-component polyurethane adhesive, 2 μm |
| Layer C (sealing layer): | sealing layer of LLDPE (linear low density |
| | polyethylene), MFI = 1.4 kg/10 min, 40 μm |

### COMPARISON EXAMPLE 4

| | |
|---|---|
| Layer A (support film): | coextruded polypropylene, biaxially oriented, 20 μm, |
| | type Walothen C20SE/two-component polyurethane |
| | adhesive 2 μm/aluminium foil 9 μm |
| Layer B: | two-component polyurethane adhesive, 2 μm |
| Layer C (sealing layer): | sealing layer of a polypropylene copolymer, 50 μm |

TABLE 1
Comparison of the properties of different composite films

| | | Comparison | | Comparison | | Comparison |
|---|---|---|---|---|---|---|
| | Example 1 | Example 1 | Example 2 | Example 2 | Example 3 | Example 3 |
| Layer A | PA6/EVOH/PA6 | PA6/EVOH/PA6 | PET | PET | C/PP/C | C/PP/C |
| | monoaxially stretched | monoaxially stretched | biaxially stretched | biaxially stretched | biaxially stretched | biaxially |
| | | | | | | stretched |
| Layer B | 2K PU adhesive | 2K PU adhesive | 2K PU adhesive | 2K PU adhesive | 2K PU adhesive | 2K PU |
| | | | | | | adhesive |
| Layer C | LLDPE | LLDPE | LLDPE | LLDPE | LLDPE | LLDPE |
| | biaxially oriented | | biaxially oriented | | biaxially oriented | |
| Layer thicknesses | 15/2/15 μm | 20/2/40 μm | 12/2/15 μm | 12/2/40 μm | 20/2/15 μm | 20/2/40 μm |
| Secant modulus | 1739/1486 | 1151/1581 | 2499/2830 | 1035/1559 | 1689/2506 | 1009/1696 |
| (longitudinal/transverse) | N/mm² | N/mm² | N/mm² | N/mm² | N/mm² | N/mm² |
| Yield strength 2% | 24.2/23.5 | 16.6/18.5 | 40.6/43.4 | 11.3/23.6 | 24.8/31.4 | 14.4/22.4 |
| (longitudinal/transverse) | N/mm² | N/mm² | N/mm² | N/mm² | N/mm² | N/mm² |
| Yield strength 5% | 38.0/33.2 | 25.0/25.9 | 62.8/58.7 | 30.9/32.0 | 33.7/54.2 | 19.2/38.9 |
| (longitudinal/transverse) | N/mm² | N/mm² | N/mm² | N/mm² | N/mm² | N/mm² |
| Tear resistance | 183.9/66.9 | 100.0/29.8 | 168.9/181.8 | 70.5/60.6 | 119.3/173.7 | 69.6/102.0 |
| (longitudinal/transverse) | N/mm² | N/mm² | N/mm² | N/mm² | N/mm² | N/mm² |
| Elongation at tear | 87.3/223.5 | 83.8/383.7 | 94.4/102.3 | 99.4/97.3 | 93.9/61.2 | 194.2/42.5 |
| (longitudinal/transverse) | % | % | % | % | % | % |
| Perforation force | 10.1 N | 7.0 N | 10.9 N | 8.9 N | 12.3 N | 11.5 N |
| Perforation path | 5.5 mm | 5.1 mm | 4.8 mm | 4.9 mm | 5.1 mm | 5.3 mm |
| Perforation work | 2.27 Ncm | 1.55 Ncm | 1.95 Ncm | 1.74 Ncm | 2.37 Ncm | 2.36 Ncm |
| Water-vapour permeability | 2.3 g/m²d | 2.0 g/m²d | 4.2 g/m²d | 2.2 g/m²d | 0.9 g/m²d | 0.8 g/m²d |
| (23° C., 85% moisture) | | | | | | |
| Strength of the seal | 33.3 N/15 mm | 44.8 N/15 mm | 24.2 N/15 mm | 40.0 N/15 mm | 32.0 N/15 mm | 42.1 N/15 mm |
| C/C 150° C. | | | | | | |
| 140° C. | 33.2 N/15 mm | 43.9 N/15 mm | 25.1 N/15 mm | 40.2 N/15 mm | 33.4 N/15 mm | 41.1 N/15 mm |
| 130° C. | 33.5 N/15 mm | 44.2 N/15 mm | 23.2 N/15 mm | 40.7 N/15 mm | 27.9 N/15 mm | 40.7 N/15 mm |
| 120° C. | 2.4 N/15 mm | 41.3 N/15 mm | 2.5 N/15 mm | 38.2 N/15 mm | 0.5 N/15 mm | 38.3 N/15 mm |
| 110° C. | — | 9.7 N/15 mm | 0.1 N/15 mm | 7.1 N/15 mm | 0.1 N/15 mm | 2.3 N/15 mm |
| 100° C. | — | 0.3 N/15 mm | — | — | — | 0.3 N/15 mm |

TABLE 2
Strength of the seal in the sealing of BOPE against BOPP (Walothen C)

| | | Comparison | | Comparison |
|---|---|---|---|---|
| | Example 3 | Example 3 | Example 4 | Example 4 |
| Layer A | PP | PP | C/PP/C biaxially | C/PP/C biaxially |
| | biaxially oriented | biaxially oriented | oriented/ | oriented/ |
| | | | KK/A1 | KK/A1 |
| Layer B | 2K PU adhesive | 2K PU adhesive | 2K PU adhesive | 2K PU adhesive |
| Layer C | LLDPE | LLDPE | LLDPE | PP/PE |
| | biaxially oriented | | biaxially oriented | copolymer |
| Layer thicknesses | 20/2/15 μm | 20/2/40 μm | 20/2/9/2/15 μm | 20/2/9/2/50 μm |
| Strength of the | 32.0 N/15 mm | 42.1 N/15 mm | 31.7 N/15 mm | 29.4 N/15 mm |
| seal | | | | |
| C/C 150° C. | | | | |
| 140° C. | 33.4 N/15 mm | 41.1 N/15 mm | 29.5 N/15 mm | 33.4 N/15 mm |
| 130° C. | 27.9 N/15 mm | 40.7 N/15 mm | 28.1 N/15 mm | 28.7 N/15 mm |
| 120° C. | 0.5 N/15 mm | 38.3 N/15 mm | 0.6 N/15 mm | 26.8 N/15 mm |
| 110° C. | 0.1 N/15 mm | 2.3 N/15 mm | 0.1 N/15 mm | 0.3 N/15 mm |
| Strength of the | 4.1 N/15 mm | 1.1 N/15 mm | 9.2 N/15 mm | — |
| seal | | | | |
| A/C 140° C. | | | | |
| 130° C. | 3.3 N/15 mm | 1.5 N/15 mm | 8.6 N/15 mm | 7.9 N/15 mm |
| 120° C. | 0.3 N/15 mm | 0.6 N/15 mm | 0.5 N/15 mm | 5.6 N/15 mm |
| 110° C. | | 0.4 N/15 mm | 0.1 N/15 mm | 0.4 N/15 mm |

The abbreviations used are explained in the description of the Examples. [2K = two-component]

1. Multilayered composite films comprising a film or film combination A of plastics layers and/or metal layers in any arrangement, characterised in that they contain an at least 10 μm thick, biaxially oriented heat-sealable layer C predominantly comprising polyethylene homopolymers or polyethylene copolymers, which is bonded by means of an adhesive layer or connecting layer B to the film or film combination A.

2. A multilayered composite film according to claim 1, characterised in that the film or film combination A comprises plastics layers and/or metal layers in any arrangement, which are bonded by adhesive or adhesion-promoting intermediate layers.

3. A multilayered composite film according to one of claims 1 or 2, characterised in that the plastics layers contained in the film or film combination A may be both non-oriented and monoaxially or biaxially oriented.

4. A multilayered composite film according to one of claims 1 to 3, characterised in that the plastics layers contained in the film or film combination A may be provided with metallic or transparent organic or inorganic layers.

5. A multilayered composite film according to one of claims 1 to 4, characterised in that the film or film combination A may contain a metal foil, preferably made of aluminium.

6. A multilayered composite film according to one of claims 1 to 5, characterised in that the film or film combination A is a gas barrier layer monoaxially oriented in the machine direction and optionally coated with a barrier layer or vacuum-coated with a transparent layer.

7. A multilayered composite film according to claim 6, characterised in that the gas barrier layer A has an oxygen permeability of at most 20 NCm³/m² d bar (23° C./0% relative humidity).

8. A multilayered composite film according to one of claims 6 or 7, characterised in that the monoaxially stretched gas barrier film A comprises polyamide (PA), polypropylene (PP) or polyethylene (PE) and is optionally provided with a barrier layer coating or transparent barrier layer applied by vacuum coating.

9. A multilayered composite film according to one of claims 6 to 8, characterised in that the monoaxially stretched gas barrier film comprises polyamide (PA) or ethylene-vinyl alcohol copolymer (EVOH) or the layered combination of PA and EVOH or of mixtures of PA and EVOH.

10. A multilayered composite film according to one of claims 1 to 5, characterised in that the outer layer of the film or film combination A comprises a coextruded, biaxially oriented polypropylene film.

11. A multilayered composite film according to claim 10, characterised in that sealing strengths of greater than 4 N/15 mm are achieved in the sealing of the biaxially oriented heat-sealable layer C against coextruded biaxially oriented polypropylene.

12. A multilayered composite film according to one of claims 1 to 11, characterised in that the biaxially oriented heat-sealable layer C may be single-layered or multilayered.

13. A multilayered composite film according to one of claims 1 to 12, characterised in that the at least single-layered, biaxially oriented heat-sealable layer C is made firmly-sealing or peelable from itself or from a second film.

14. A multilayered composite film according to one of claims 1 to 13, characterised in that each of the layers of the at least single-layered, biaxially oriented heat-sealable layer C comprises polyethylene homopolymers or polyethylene copolymers and mixtures or coextrusions of these materials.

15. A multilayered composite film according to one of claims 1 to 14, characterised in that the layers of the at least single-layered, biaxially oriented heat-sealable layer C comprises at least 50% of LLDPE.

16. A multilayered composite film according to one of claims 1 to 15, characterised in that the layers of the at least single-layered, biaxially oriented heat-sealable layer C each have an MFI of less than 2.

17. A multilayered composite film according to one of claims 1 to 16, characterised in that the layers of the at least single-layered, biaxially oriented heat-sealable layer C each have a density of less than 0.94 g/cm³.

18. A multilayered composite film according to one of claims 1 to 17, characterised in that the layers of the at least single-layered, biaxially oriented heat-sealable layer C comprises a mixture of LLDPE itself comprising at most 50% LLDPE.

19. A multilayered composite film according to one of claims 1 to 18, characterised in that the layers of the at least single-layered, biaxially oriented heat-sealable layer C comprises a mixture of LLDPE itself comprising at most 50% polyethylene copolymers.

20. A multilayered composite film according to one of claims 1 to 19, characterised in that the biaxially oriented heat-sealable layer C is present in a thickness of from 10 to 50 μm.

21. A multilayered composite film according to one of claims 1 to 20, characterised in that the biaxially oriented heat-sealable layer C is present in a thickness preferably of from 10 to 30 μm.

22. A multilayered composite film according to one of claims 1 to 21, characterised in that the film or film combination A and the biaxially oriented heat-sealable layer C are bonded by means of an adhesive layer B comprising one- or two-component polyurethane adhesive or an olefinic adhesion promoter.

23. A multilayered composite film according to one of claims 1 to 22, characterised in that the composite film is printed.

24. The use of the multilayered composite film according to one of claims 1 to 23 for the packaging of foods.

25. The use of the multilayered composite film according to one of claims 1 to 23 as film for balloons.

26. The use of the multilayered composite film according to one of claims 1 to 23 as covering film for deep-drawn packaging materials.

27. The use of the multilayered composite film according to one of claims 10 and 11 for packaging materials having an overlapping sealing seam (“lap seal”).
